(19) United States
(12) Patent Application Publication
(10) Pub. No.: US 2026/0291263 A1
(43) Pub. Date: Sep. 24, 2026

(54) Reconfigurable Cell Array

(71) Applicant: Hydrogen Energy Company, LLC, Byron Center, MI (US)

(72) Inventors: Ted Hollinger, Greenville, TN (US); Ellington Ellis, Byron Center, MI (US)

(73) Assignee: Hydrogen Energy Company, LLC, Byron Center, MI (US)

(21) Appl. No.: 19/086,360

(22) Filed: Mar. 21, 2025

(51) Int. Cl. H02J 7/50; H02J 7/35

(52) U.S. Cl. CPC H02J 7/50; H02J 7/35

(57) ABSTRACT

A reconfigurable cell array having at least two cells, where each cell has a first terminal and a second terminal, where one of the first terminal and the second terminal is an anode and another of the first terminal and the second terminal is a cathode. Also included are a power input terminal, a power output terminal, wiring for making electrical connections between the cells and both the power input terminal and the power output terminal, and switches for selectively changing the electrical connections between at least one of a series configuration between selected ones of the cells, a parallel configuration between selected ones of the cells, and isolating selected ones of the cells.

### FIELD

This invention relates to the field of electrical storage systems. More particularly, this invention relates to a reconfigurable electrical storage cell system.

### INTRODUCTION

Electrical charge can be stored in storage systems that are, for example, chemically based, such as batteries, or materials based, such as capacitors. Although these various storage systems may differ in their benefits and drawbacks as used for different purposes, all such are referred to as cells herein, for simplicity.

Charging a cell typically requires a tradeoff between charging time and charging power. If the cell is a relatively low power cell, then this is not a big issue, either in terms of time or available power. However, for a relatively higher-power cell, it can become an overwhelming issue. For example, a one-megawatt cell might require 100 kilowatts for ten hours to charge, or alternately, it could be charged at 1000 kilowatts for just one hour. Thus, if a high-power source is available, then the charging time can be dramatically reduced.

As a further example, superchargers for electric vehicles (EVs), can require a power of 350kW or more. This requirement surpasses the electrical capacity of most homes and small businesses, making rapid EV charging at these locations unfeasible. A typical residential location is equipped with a 15kW transformer, with the household consuming approximately 3kW at any given time. This leaves around 12kW for EV charging, translating to a daily availability of 288kWh.

The Tesla™ Model 3 all-wheel drive, long-range model has a battery size of about 82kWh. The GMC™ Hummer™ EV currently has the largest rated EV battery capacity at 247kWh. With recommended charging ranges of from about 10% to about 90%. Charging an 82kWh battery with 12kW could span nearly seven hours, which could be done overnight. However, charging the 247kWh battery would require almost 21 hours. Of course, this is entirely impractical if one wants to use the EV on a daily basis for more than just a handful of hours. Thus, there's a need for a high-power source that is compatible with home electrical systems.

Unfortunately, in many situations, such a high-power source is not available, because either or both of the requisite voltage or amperage cannot be delivered. Further, even if such a high-power source is available, then it might only be available at a price that is higher than what is practical for the given application. Further still, renewable electrical energy sources such as wind and solar generation, which can be provided off-grid in relatively remote locations, are very rarely able to achieve such high-power outputs.

What is needed, therefore, is a system that tends to reduce issues such as those described above, at least in part.

### SUMMARY

The above and other needs are met by a reconfigurable cell array having at least two cells, where each cell has a first terminal and a second terminal, where one of the first terminal and the second terminal is an anode and another of the first terminal and the second terminal is a cathode. Also included are a power input terminal, a power output terminal, wiring for making electrical connections between the cells and both the power input terminal and the power output terminal, and switches for selectively changing the electrical connections between at least one of a series configuration between selected ones of the cells, a parallel configuration between selected ones of the cells, and isolating selected ones of the cells.

In some embodiments, a method of using the reconfigurable cell array includes the following steps. When charging the reconfigurable cell array, connecting a power source to the power input terminal, setting the switches for a parallel configuration of the electrical connections, and receiving a charge from the power source at a relatively lower power for a relatively longer amount of time. When discharging the reconfigurable cell array, connecting a connected device to the power output terminal, setting the switches for a series configuration of the electrical connections, and expending the charge to the connected device at a relatively higher power for a relatively shorter amount of time.

In some embodiments, the power source is at least one of a solar panel, a windmill, a hydroelectric generator, and a commercial power grid. In some embodiments, the receiving device is at least one of a battery of an electric vehicle, a laser system, and an electrolyzer.

In some embodiments, a processing unit is provided for controlling the configuration of the switches, with an interface for programming the processing unit. In some embodiments, the interface includes a wireless communication module for receiving remote programming instructions. In some embodiments, the processing unit adaptively switches the configuration of the switches based on energy needs of the connected device. In some embodiments, a cooling system is provided for cooling at least portions of the reconfigurable cell array. In some embodiments, the reconfigurable cell array is disposed on a mobile platform.

### BRIEF DESCRIPTION OF THE DRAWINGS

Further advantages of the invention are apparent by reference to the detailed description when considered in conjunction with the figures, which are not to scale so as to more clearly show the details, wherein like reference numbers indicate like elements throughout the several views, and wherein:

FIGS. 1A – 1C depict a ten-cell embodiment of a reconfigurable cell array according to an embodiment of the present disclosure.

FIGS. 2A – 2E depict a two-cell embodiment of a reconfigurable cell array according to an embodiment of the present disclosure.

FIGS. 3A – 3B depict a four-cell embodiment of a reconfigurable cell array according to an embodiment of the present disclosure.

FIG. 4 depicts a thirty-cell embodiment of a reconfigurable cell array according to an embodiment of the present disclosure.

FIG. 5 depicts a functional block diagram of an electronics control package of a reconfigurable cell array according to an embodiment of the present disclosure.

### DESCRIPTION

The embodiments described herein include multiple cells into a system that is designed to be reconfigured in a manner that modulates the voltage output by the system without relying on magnetic coupling. This system not only facilitates voltage conversion but also serves as an energy storage unit. For EV charging, the batteries can be set to charge over extended durations and then swiftly reconfigured for rapid discharge. Electronic controls manage the switching and regulation of the system's output. In homes equipped with solar systems, the batteries can transition between a solar voltage (such as 36V) and an EV charging voltage (such as 400V) as desired.

In general, the embodiments of the system can be configured to charge over a relatively longer period of time at a relatively lower voltage, and then reconfigured to discharge over a relatively shorter period of time at a relatively higher voltage. Thus, charging of the system from the example given above at 12kW for use with a 247kWh EV battery could be performed over the period of most of a day, as explained above, while the EV is being used elsewhere. Then, when the EV is to be recharged, the fully-charged system is reconfigured to deliver the stored charge at 120kW, for example, for just a bit more than two hours. Thus, the EV does not need to be connected to the power source for an extended period of time, and the user receives the benefit of (near) supercharging in a household setting.

With reference now to the drawings, there are depicted all of the claimed elements of the various embodiments, although all claimed embodiments might not be depicted in a single drawing. Thus, it is appreciated that not all embodiments include all of the elements as depicted, and that some embodiments include different combinations of the depicted elements. It is further appreciated that the various elements can all have many different configurations, and are not limited to just the configuration of a given element as depicted. As indicated above, the elements of the drawings as depicted are not to scale, even with respect one to another, and relative size or thickness of one element cannot be determined by the aspect ratios of that element or with reference to any dimension of another element.

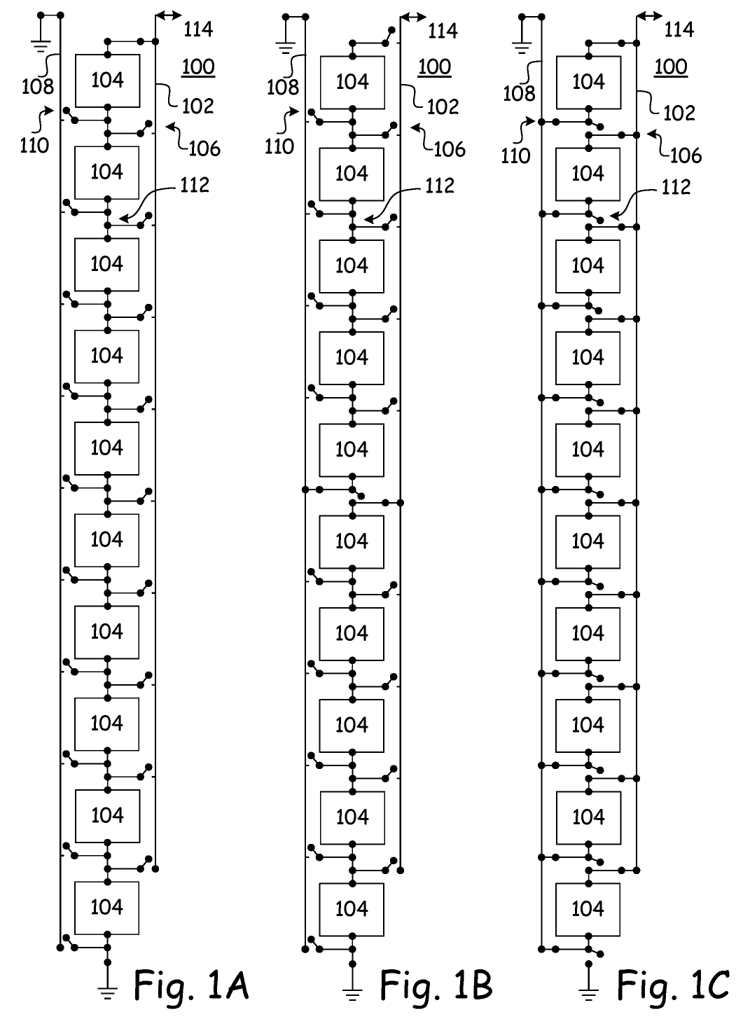

With reference now to FIGS. 1A-1C, there is depicted an embodiment of the reconfigurable cell array 100 with ten cells 104, which can be configured via switches to be charged and discharged in various combinations of parallel and series configurations of different numbers of the cells 104. It is appreciated that the number of ten cells 104 is used as an example in FIGS. 1A-1C, and that in other embodiments, either a greater or a lesser number of cells 104 could be employed in the reconfigurable cell array 100.

In these embodiments, the cells 104 are both charged and discharged via a combined input terminal and output terminal 114.

In general, each cell 104 has associated with it three different switches. A switch 106 disposed immediately “above” the cell 104 (as depicted in this example) selectively electrically couples the cell 104 to the rail 102, which in this embodiment is connected to the input/output 114. A switch 110 disposed immediately “below” the cell 104 (as depicted in this example) selectively electrically couples the cell 104 to the rail 108, which is connected to ground. These two switches 106 and 110 can be used to put each cell 104 in a parallel configuration. A switch 112 disposed between adjacent cells 104 is used to selectively electrically couples the two adjacent cells 104 in a series configuration.

As depicted in FIG. 1A, the switches are all set so as to configure all of the cells 104 in a series configuration. In this series configuration, the output of the reconfigurable cell array 100 on 114 is the sum of all of the voltages of the cells 104 in the reconfigurable cell array 100. Thus, a reconfigurable cell array 100 that is set to output a charge in this configuration can deliver that charge at a relatively high voltage.

As depicted in FIG. 1B, the first five cells 104 are electrically isolated both from the ground rail 108 and the input/output rail 102, and the last five cells 104 are set by their switches to be in a series configuration. Thus, if all of the cells 104 have the same individual voltage, the reconfigurable cell array 100 would deliver a charge at about one-half of the total voltage as that delivered by the reconfigurable cell array 100 as configured in FIG. 1A.

As depicted in FIG. 1C, all ten of the cells 104 are electrically connected to both the input/output rail 102 and the ground rail 108 in a parallel configuration. Such a configuration is useful, for example, when charging the reconfigurable cell array 100 on the rail 102 at a relatively lower voltage, such as might be more conveniently available in a residential setting. Once charged in this manner, the reconfigurable cell array 100 could then be configured as depicted in FIG. 1A to deliver a charge that is nominally ten times the voltage of each individual cell 104, which would be useful, for example, for charging an EV.

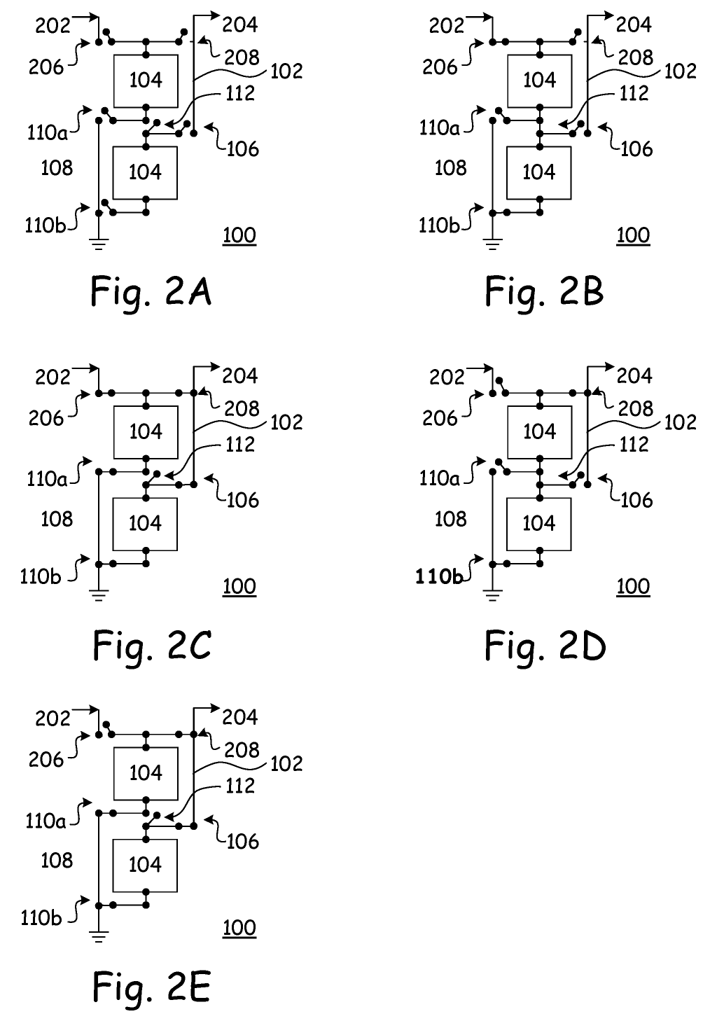

With reference now to FIG. 2A, there is depicted a two-cell 104 embodiment of the reconfigurable cell array 100, with all of the switches in an open position. As depicted in FIG. 2A, each cell 104 can be configured via switches to receive power from an input terminal 202 in either a series or a parallel configuration with the other cell 104, and each cell 104 can be configured via switches to provide power to an output terminal 204 in either a series or a parallel configuration with the other cell 104. With all of the switches open as depicted, the cells 104 are isolated from each other, the input terminal 202, and the output terminal 204, and cannot transfer, receive, or expend any electrical charge.

This same configuration of switches can be applied to a greater number of cells 104. FIGS. 2A-2E only depict two cells 104 so as to not unduly encumber the drawings with repetitive information that can be adequately shown with just two cells 104.

As depicted in FIG. 2B, switches 206, 112, and 110b have been closed, relative to the initial open position of the switches in FIG. 2A. In this configuration, both of the cells 104 receive power through the input terminal 202 in a series configuration.

When the reconfigurable cell array 100 is charged in a series configuration, it will typically require a relatively higher input voltage. Thus, for many of the applications described herein, a series configuration might not be optimal for charging the reconfigurable cell array 100. This configuration is depicted so as to show the versatility of the reconfigurable cell array 100.

As depicted in FIG. 2C, switches 206, 208, 106, 110a, and 110b have been closed, relative to the initial open position of the switches in FIG. 2A. In this configuration, both of the cells 104 receive power through the input terminal 202 in a parallel configuration. When the reconfigurable cell array 100 is charged in a parallel configuration, it will typically require a relatively lower input voltage. Thus, for many of the applications described herein, a parallel configuration might be optimal for charging the reconfigurable cell array 100.

As depicted in FIG. 2D, switches 208, 112, and 110b have been closed, relative to the initial open positions of the switches in FIG. 2A. In this configuration, both of the cells 104 expend electrical charge through the output terminal 204 in a series configuration. When the reconfigurable cell array 100 is discharged in a series configuration, it will typically do so at a relatively higher output voltage. Thus, for many of the applications described herein, a series configuration might be optimal for discharging the reconfigurable cell array 100.

As depicted in FIG. 2E, switches 208, 106, 110a, and110b have been closed, relative to the initial open positions of the switches in FIG. 2A. In this configuration, both of the cells 104 expend electrical charge through the output terminal 204 in a parallel configuration. When the reconfigurable cell array 100 is discharged in a parallel configuration, it will typically do so at a relatively lower output voltage. Thus, for many of the applications described herein, a parallel configuration might not be optimal for discharging the reconfigurable cell array 100.

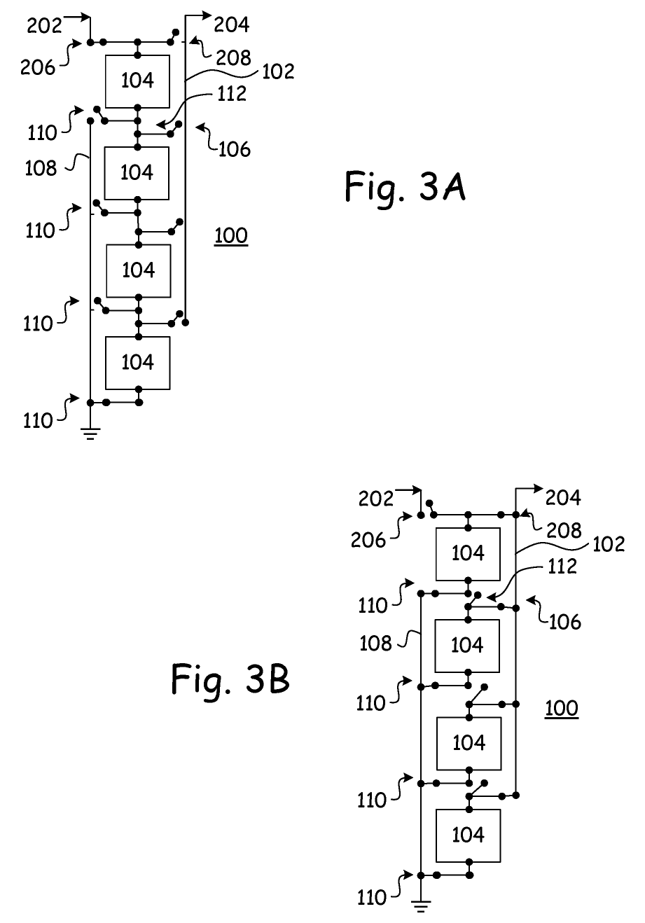

With reference now to FIGS. 3A and 3B, there are depicted embodiments of the reconfigurable cell array 100 with four cells 104. As configured in FIG. 3A, the reconfigurable cell array 100 has the switches set for series charging of the four cells 104 through the power input 202. As configured in FIG. 3B, the reconfigurable cell array 100 has the switches set for parallel discharging of the four cells 104 through the power output 204.

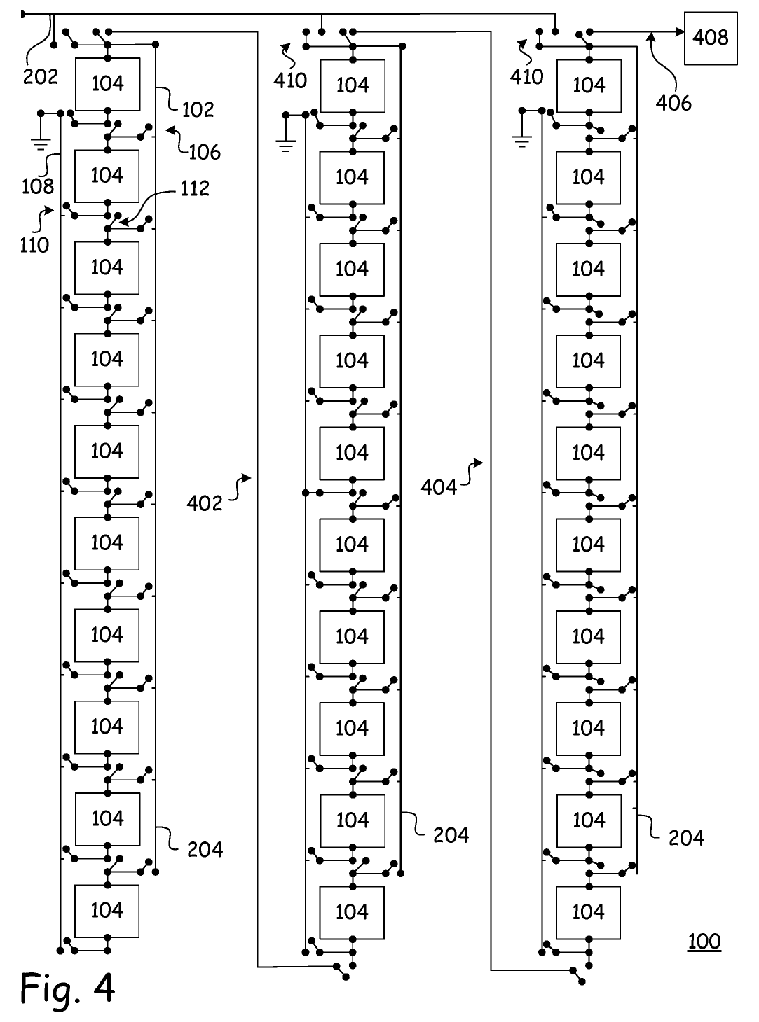

With reference now to FIG. 4, there is depicted an embodiment of the reconfigurable cell array 100 in which three strings or stages of cells 104 are connected between the input rail 202 and the output rails 204. A configuration such as depicted in FIG. 4 can be used, in some embodiments, to power a laser system 408, such as described below.

The laser system 408 in some embodiments is a high energy laser with integrated optical dazzler and surveillance (HELIOS). This pulsed energy system uses a three-stage embodiment of the reconfigurable cell array 100. A first stage 402 of cells 104 comprised of batteries is used for the initial storage of energy. The first stage 402 receives the charge in a parallel configuration, and then outputs the charge in a series configuration at an increased voltage of at least about 500V.

This charge is received in a parallel configuration by a second stage 404 of cells 104 that is comprised of electrolytic capacitors. Switch 410 can be set, for example, in any one of three different positions. For example, switch 410 can be open, in which there is no voltage input on the second stage 404. In a second position, the switch 410 can make an electrical connection with the output 204 of the first stage 402. In a third position, the switch 410 can make an electrical connection with the input rail 202, and receive the standard voltage input that is provided on that input rail 202.

The charge from the second stage 404 is output in a series configuration at an increased voltage of at least about 5000V, by setting the switch 410 at the input of the third stage 406 to receive the charge from the output 204 of the second stage 404..

The output charge of the second stage 404 is received in a parallel configuration by a third stage 406 of cells 104 that is comprised of oil-filled high-performance capacitors. The charge from the third stage 406 is output to the laser 408 in a series configuration at an increased voltage of at least about 50,000V.

FIG. 4 is depicted with all of the various switches in their open positions, but the descriptions provided with FIGS. 1-3 will be sufficient for one of ordinary skill in the art to understand how to set the switches for parallel charging and serial discharging of the stages 402. 404, and 406.

The batteries of the first stage 402 and the electrolytic capacitors of the second stage 404 cannot charge and discharge fast enough to pulse the laser 408. Thus, the embodiment as depicted uses three stages 402, 404, and 406 of cells 104 in what is termed herein a Gatling gun arrangement where, at any given time, at least one stage is charging and one stage is discharging. This embodiment capitalizes on three aspects of the reconfigurable cell array 100, which include batteries 104 in the first stage 402 for energy storage, electrolytic capacitors 104 in the second stage 404 for high voltage, and high-performance capacitors 104 in the third stage 406 for quick energy release.

### Electronic Control System

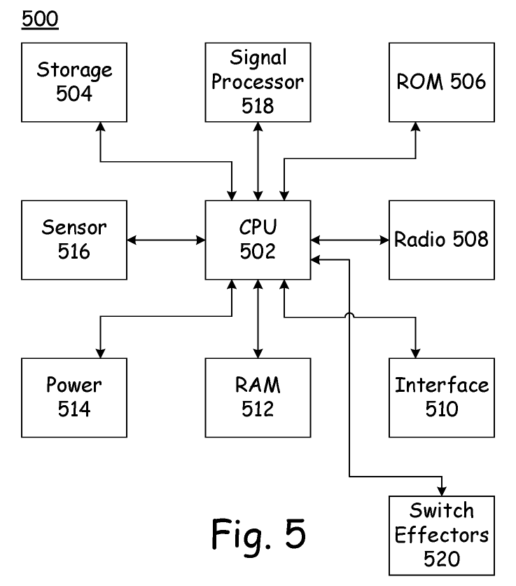

With reference now to FIG. 5, there is depicted one embodiment of a computerized apparatus 500 capable of controlling the reconfigurable cell array 100 as described herein. The apparatus 500 is at least one of a special purpose computing device, a tablet computer, a smart phone, a smart watch, a component level processor, an application specific integrated circuit, or some other computing device.

In some embodiments, the sensor 516 includes at least one of a thermal sensor, a voltage meter, a GPS receiver, and an ammeter. The radio module 508 provides a gateway for the communication of data and instructions between the apparatus 500 and other computing devices, networks, or data storage modules. In some embodiments, the radio 508 enables data communication over a wireless connection, including at least one of RFID, Bluetooth, UWB, cellular, Zigbee, and Z-Wave.

In this embodiment, the apparatus 500 is locally under the control of the central processing unit 502, which controls and utilizes the other modules of the apparatus 500 as described herein. As used herein, the word module refers to a combination of both software and hardware that performs at least one designated function. Thus, in different embodiments, various modules might share elements of the hardware as described herein, and in some embodiments might also share portions of the software that interact with the hardware. In some other embodiments, a given module might be spread across different computer platforms.

The apparatus 500 as depicted in FIG. 5 includes, in some embodiments, a non-transitory, computer-readable, data storage medium module 504 such as a flash drive, or some other relatively long-term data storage device. A read-only memory module 506 contains, for example, basic operating instructions for the operation of the apparatus 500. An interface module 510 includes, for example, keyboards, speakers, microphones, cameras, displays, and touchpads, and provides means by which the user can interact with the apparatus 500.

The switch effector module 520 contains mechanical or electronic elements as desired to open and close the electrical pathways of the various switches described herein.

A random-access memory module 512 provides short-term storage for data, such as cell 104 charging levels, temperatures, input power levels, output power levels, and programming instructions for the operation of the apparatus 500. A power module 514 is also provided in various embodiments of the apparatus 500. In some embodiment that power module 514 is separate from the cells 104.

In some embodiments the steps of the various functions described herein are embodied in a computer language on a non-transitory, computer-readable, data storage medium that is readable by the apparatus 500 of FIG. 5, and that enables the apparatus 500 to implement the functions as described herein, such as a removable memory card.

### EV Semi-Truck Embodiment

EV trucks have already made their way onto the roads. Some semi-trucks require approximately 1MWh of battery storage using, for example, 1MW of utility power to charge the battery in one hour, 2MW for 30 minutes, and 4MW for 15 minutes. This high peak demand poses a significant problem for utilities, as it drives up the cost of electrical power. Many states impose peak demand charges that can exceed $15 per kW, equating to $15,000 for 1MW. This monthly charge would need to be distributed among the users each month. Compounding the issue is the scarcity of charging stations and the fact that utilities are not prepared to supply the high peak power needed to quickly charge a semi-truck.

The battery voltage for an EV semi ranges between 800V and 1000V, which is higher than the rectified 480three-phase voltage of 650V. Additionally, high power lines are intentionally not parallel to major highways, with the cost of extending these lines exceeding $1 million per mile.

Thus, the available utility power is typically too low in voltage, too low in amperage, and too expensive during the truckers' typical time of use. The reconfigurable cell array 100 described herein uses batteries to store energy at the available voltage and reconfigure it to meet the semi-trucks' voltage and power requirements. This is accomplished by charging the batteries of the reconfigurable cell array 100 from the utility power grid in parallel, and then discharging them in series to charge the semi-trucks.

In various embodiments, the reconfigurable cell array 100 is configured in either a 20-foot or 40-foot shipping container, requiring only incoming power connections to be ready for use. It includes its own power meter and email address, with system status available via an app. Reservations for charging can be made through email or website. The end user contacts the reconfigurable cell array 100, places an order, and a representative ensures site compatibility before contacting the local utility to schedule the power line connection. The reconfigurable cell array 100 coordinates the shipment and installation, and the representative assists the utility as needed, checking communications and equipment operation. Once complete, the end user receives training on operating the reconfigurable cell array 100, which is then turned over to the buyer.

In various embodiments, the reconfigurable cell array 100 maintains internet surveillance and communication with the buyer. The 40-foot reconfigurable cell array 100, for example, has two charging cables, allowing it to charge two trucks simultaneously. Each charger can handle 1MWh of charging, and partial charging is permitted. The reconfigurable cell array 100 charges itself with off-peak power at the lowest compatible power level with the utility rate structure. Utilizing 240 single-phase power at 200 amps, it takes about 12 hours to charge the reconfigurable cell array 100 fully.

The reconfigurable cell array 100 can be monitored from anywhere using an app installed on a cell phone or computer. Installation can be completed in a few hours, and the reconfigurable cell array 100 can be disconnected from the utility and relocated as needed. It is not sensitive to utility frequency, operating with 50 or 60 hertz or any other frequency as long as power is available. Housed in a lockable, self-contained, weather-proof shipping container, the reconfigurable cell array 100 ensures durability and ease of use.

### Additional Embodiments

The proposed reconfigurable cell array 100, in various embodiments, includes multiple batteries in a reconfigurable cell array 100 that is designed for reconfiguration to modulate the output voltage without relying on magnetic coupling. This reconfigurable cell array 100 not only enables voltage conversion, but also serves as an energy storage unit. For EV charging, the reconfigurable cell array 100 can be set to charge over extended durations and then swiftly reconfigured for rapid discharge. Electronic controls manage the switching and regulation of the output of the reconfigurable cell array 100. In homes equipped with solar systems, the cells 104 can transition between standard solar voltage (36V) and EV charging voltage (400V) as desired.

Various embodiments describe a reconfigurable cell array 100 designed with two or more cells 104 that can be reconfigured into parallel, series, or series-parallel configurations. These configurations hold the potential for voltage reversal in some or all batteries, enhancing the versatility of the reconfigurable cell array 100.

The reconfiguration plays a crucial role in boosting the efficiency of electric vehicle (EV) charging and optimizing the operation of low-voltage electrolyzers. This reconfigurable cell array 100 allows EV or other battery power to be channeled to a reconfigurable cell array 100, ensuring a seamless energy flow.

The reconfigurable cell array 100 manages and operates multiple reconfigurable cell array 100 units simultaneously, enabling certain cells 104 to charge while others discharge. Integration with solar panels harnesses renewable energy for charging, while electronic controls facilitate seamless switching between configurations. This adaptive reconfigurable cell array 100 can switch configurations based on the energy needs of the connected device, whether it is an EV, laser system, or an electrolyzer.

Moreover, the reconfigurable cell array 100 integrates with gensets or other alternative power sources, ensuring an uninterrupted power supply. The cells 104 within the reconfigurable cell array 100 can self-diagnose and report their health status, ensuring optimal performance and safety. Machine learning algorithms predict the best times for charging and discharging based on historical usage patterns and external factors like weather.

The reconfigurable cell array 100 also connects with smart home or smart grid systems, allowing for dynamic energy distribution based on real-time needs and priorities. A user-friendly interface enables users to manually select or override automated configurations for specific requirements. Thermal management components ensure efficient cooling during high-current operations, extending the lifespan of the cells 104.

Wireless communication with other devices facilitates remote monitoring and control of the charging and discharging processes. Advanced safety mechanisms, including surge protection and short-circuit prevention, protect both the device and connected equipment. The reconfigurable cell array 100 can adaptively manage energy distribution when connected to multiple devices, ensuring optimal charging for each based on individual needs.

Finally, the reconfigurable cell array 100 incorporates eco-friendly materials and design principles, minimizing its environmental footprint and promoting sustainable energy solutions. Modular components allow for easy upgrades or replacements, ensuring longevity and adaptability to future technological advancements.

The reconfigurable cell array 100 can be leveraged as a fixed energy storage solution, ensuring a consistent power supply for various applications and acting as a backup during power outages or periods of high demand. Additionally, the reconfigurable cell array 100 can be adapted for rapid charging station applications, significantly reducing wait times and enhancing user convenience, thus encouraging the adoption of electric vehicles (EVs). Homeowners can also implement the reconfigurable cell array 100 for accelerated home-based EV charging stations, allowing for more efficient use of household energy and reducing reliance on public charging stations.

Moreover, the reconfigurable cell array 100 can be utilized for decentralized power distribution hubs, enhancing grid resilience and reducing the strain on centralized power systems. It can serve as a bi-directional power source, facilitating vehicle-to-home (V2H) and vehicle-to-business (V2B) energy transfer, enabling EVs to supply power back to buildings during peak demand or emergencies. By introducing the reconfigurable cell array 100 within a mobile energy storage vehicle, it can rejuvenate EVs, especially those low on power or stranded in remote locations, ensuring continuous mobility.

Incorporating the reconfigurable cell array 100 in battery exchange stations can expedite the recharging process, allowing users to quickly swap out depleted batteries for fully charged ones without waiting for recharging. Furthermore, integrating the reconfigurable cell array 100 with renewable energy sources, such as solar or wind, creates a sustainable energy storage and distribution system, reducing carbon footprints and promoting green energy. Emergency response vehicles can also benefit from the reconfigurable cell array 100, ensuring a continuous power supply during critical operations or disaster recovery scenarios.

The reconfigurable cell array 100 is adaptable for marine applications, providing rapid charging solutions for electric boats or underwater equipment, supporting sustainable maritime activities and reducing dependency on fossil fuels. In aviation, the reconfigurable cell array 100 can offer fast-charging solutions for electric aircraft or drones, enabling quicker turnaround times and enhancing the efficiency of air transportation. Public transportation hubs can integrate the reconfigurable cell array 100 to ensure quick charging for electric buses or trams, minimizing downtime and promoting efficient public transit systems.

In critical infrastructure, such as hospitals or data centers, the reconfigurable cell array 100 can serve as a backup power source, maintaining uninterrupted operations during power outages or emergencies, thereby safeguarding essential services and information. Entertainment venues, like amusement parks or concert arenas, can leverage the reconfigurable cell array 100 to quickly charge electric rides or equipment, enhancing visitor experience and operational efficiency. The reconfigurable cell array 100 is also well-suited for agricultural applications, ensuring electric farm equipment remains operational with minimal downtime, supporting sustainable farming practices and reducing operational disruptions.

Remote research facilities, such as those in polar regions or deep forests, can utilize the reconfigurable cell array 100 to ensure a consistent power supply, enabling uninterrupted scientific exploration and data collection. In military applications, the reconfigurable cell array 100 provides rapid charging solutions for electric combat vehicles or equipment, ensuring readiness and operational efficiency in various scenarios.

As used herein, the phrase “at least one of A, B, and C” means all possible combinations of none or multiple instances of each of A, B, and C, but at least one A, or one B, or one C. For example, and without limitation: Ax1, Ax2 + Bx1, Cx2, Ax1 + Bx1 + Cx1, Ax7 + Bx12 + Cx113. It does not mean Ax0 + Bx0 + Cx0.

The foregoing description of embodiments for this invention has been presented for purposes of illustration and description. It is not intended to be exhaustive or to limit the invention to the precise form disclosed. Obvious modifications or variations are possible in light of the above teachings. The embodiments are chosen and described in an effort to provide illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. A reconfigurable cell array, comprising:
at least two cells, each cell having a first terminal and a second terminal, where one of the first terminal and the second terminal is an anode and another of the first terminal and the second terminal is a cathode,
a power input terminal,
a power output terminal,
wiring for making electrical connections between the cells and both the power input terminal and the power output terminal, and
switches for selectively changing the electrical connections between at least one of a series configuration between selected ones of the cells, a parallel configuration between selected ones of the cells, and isolating selected ones of the cells.

2. A method of using the reconfigurable cell array of claim 1, the method comprising the steps of:
when charging the reconfigurable cell array,
connecting a power source to the power input terminal,
setting the switches for a parallel configuration of the electrical connections, and
receiving a charge from the power source at a relatively lower power for a relatively longer amount of time, and
when discharging the reconfigurable cell array,
connecting a connected device to the power output terminal,
setting the switches for a series configuration of the electrical connections, and
expending the charge to the connected device at a relatively higher power for a relatively shorter amount of time.

3. The method of claim 2, wherein the power source is at least one of a solar panel, a windmill, a hydroelectric generator, and a commercial power grid.

4. The method of claim 2, wherein the receiving device is at least one of a battery of an electric vehicle, a laser system, and an electrolyzer.

5. The reconfigurable cell array of claim 1, further comprising:
a processing unit for controlling the configuration of the switches, and
an interface for programming the processing unit.

6. The reconfigurable cell array of claim 5, wherein the interface further comprises a wireless communication module for receiving remote programming instructions.

7. The reconfigurable cell array of claim 5, wherein the processing unit adaptively switches the configuration of the switches based on energy needs of the connected device.

8. The reconfigurable cell array of claim 1, further comprising a cooling system for cooling at least portions of the reconfigurable cell array.

9. The reconfigurable cell array of claim 1, wherein the reconfigurable cell array is disposed on a mobile platform.

10. The reconfigurable cell array of claim 1, wherein multiple arrays are cascaded, with a first array having batteries for cells, a second array having capacitors for cells, and a third array having high-frequency capacitors for cells.

11. The reconfigurable cell array of claim 1, wherein capacitors are used for cells and the output voltage is controlled by frequency.
